(19) United States
(12) Patent Application Publication
(10) Pub. No.: US 2009/0230750 A1
(43) Pub. Date: Sep. 17, 2009

(54) INFINITELY ADJUSTABLE ARMREST FOR SEAT

(76) Inventors: Paul A. Elio, Phoenix, AZ (US); James Esler, Phoenix, AZ (US)

Correspondence Address: ROBERT A. PARSONS, 4000 N. CENTRAL AVENUE, SUITE 1220, PHOENIX, AZ, 85012, US

(21) Appl. No.: 12/403,700

(22) Filed: Mar. 13, 2009

Related U.S. Application Data
(60) Provisional application No. 61/036,402, filed on Mar. 13, 2008.

(51) Int. Cl. B60N 2/46

(52) U.S. Cl. 297/411.38

(57) ABSTRACT

Apparatus includes an inner tube affixed to a seatback and an outer tube affixed to an armrest and coaxially mounted over the inner tube. A substrate is affixed to the outer tube and a slave link is pivotally attached to the inner tube with a lock link pivotally attached to the slave link for reciprocal movement. A lock mechanism is movable between a locked position in which the lock mechanism frictionally engages the lock link and an unlocked position in which the lock link is free to slide relative to the lock mechanism. An adjustment lever moves the lock mechanism from the locked position into the unlocked position. A spring biases the lock mechanism into the locked position to hold the lock link and the armrest in a selected position.

### CROSS-REFERENCE TO RELATED APPLICATIONS

This application claims the benefit of U.S. Provisional Application No. 61/036,402 filed Mar. 13, 2008.

### FIELD OF THE INVENTION

This invention relates to an armrest for a seat, and more specifically an armrest that is infinitely adjustable over a defined range of motion.

### BACKGROUND OF THE INVENTION

In the field of seating devices, it is often desirable to have seats with adjustable armrests. This permits the armrest to maintain a level orientation with an associated floor while the back of the seating device is adjusted to alter the inclination thereof. The armrest can also be adjusted to provide the desired orientation for comfort for the differing sizes and shapes of individuals using the seat. Often, seat armrests are limited to a down position or an up position, with no variable adjustments between the two positions. Other devices have been developed which allow adjustment in a limited range, or at limited and specific positions. As an example, ratchet type mechanisms are often employed in armrests to provide adjustability. The ratcheting mechanism, however, limits the adjustments of the arm rest to specific positions due to the operation of the mechanism.

It would be highly advantageous, therefore, to remedy the foregoing and other deficiencies inherent in the prior art.

### SUMMARY OF THE INVENTION

Briefly, to achieve the desired objects and advantages of the instant invention apparatus is provided mounting an armrest to a seatback with infinite adjustments. It will be understood that the term “infinite adjustment” refers to the adjustability of the armrest being continuously moveable and lockable anywhere between the limits. The apparatus includes an inner tube affixed to the seatback and an outer tube affixed to the armrest and coaxially mounted over the inner tube so as to rotatably nest the outer tube over the inner tube. A substrate is affixed to the outer tube, and a guide is formed on the substrate. A slave link is pivotally attached to the inner tube. A lock link is pivotally attached to the slave link so as to be positioned in the guide in the substrate and is movable relative to the substrate. A lock mechanism is movably mounted on the substrate. The lock link is slideably engaged with the lock mechanism for relative movement between the lock link and the lock mechanism, the lock mechanism being movable between a locked position in which the lock mechanism frictionally engages the lock link and an unlocked position in which the lock link is free to slide relative to the lock mechanism. An adjustment lever is positioned to temporarily move the lock mechanism from the locked position into the unlocked position and a spring is coupled between the substrate and the lock mechanism for biasing the lock mechanism into the locked position to hold the lock link and the armrest in a selected position.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a side elevational view of an infinitely adjustable armrest in accordance with an embodiment of the present invention;

FIG. 2 is a side elevational view of a substrate portion of the armrest of FIG. 1;

FIG. 3 is an isometric view of the substrate portion of the armrest of FIG. 3;

FIG. 4 is an isometric view of the view of an outer tube portion of the armrest of FIG. 1;

FIG. 5 is an isometric view of an inner tube portion of the armrest of FIG. 1;

FIG. 6 is a sectional side view of the inner tube portion of the armrest of FIG. 5;

FIG. 7 is an end view of the inner tube portion of the armrest of FIG. 5;

FIG. 8 is an isometric view of a lock portion of the armrest of FIG. 1;

FIG. 9 is an exploded view of the infinitely adjustable armrest of FIG. 1;

FIG. 10 is a side elevational view of the infinitely adjustable armrest in an upright or vertical position and in a lower or horizontal position;

FIG. 11 is an exploded view in perspective of another embodiment of infinitely adjustable armrest in accordance with the present invention;

FIG. 12 is a view in perspective of the infinitely adjustable armrest of FIG. 11 assembled, portions thereof removed to illustrate inner components;

FIG. 13 is a view in perspective of the infinitely adjustable armrest of FIG. 11 assembled within an enclosing housing; and

FIG. 14 is a top plan view of the armrest assembled within an enclosing housing and attached to a portion of a seat back.

### DETAILED DESCRIPTION OF THE DRAWINGS

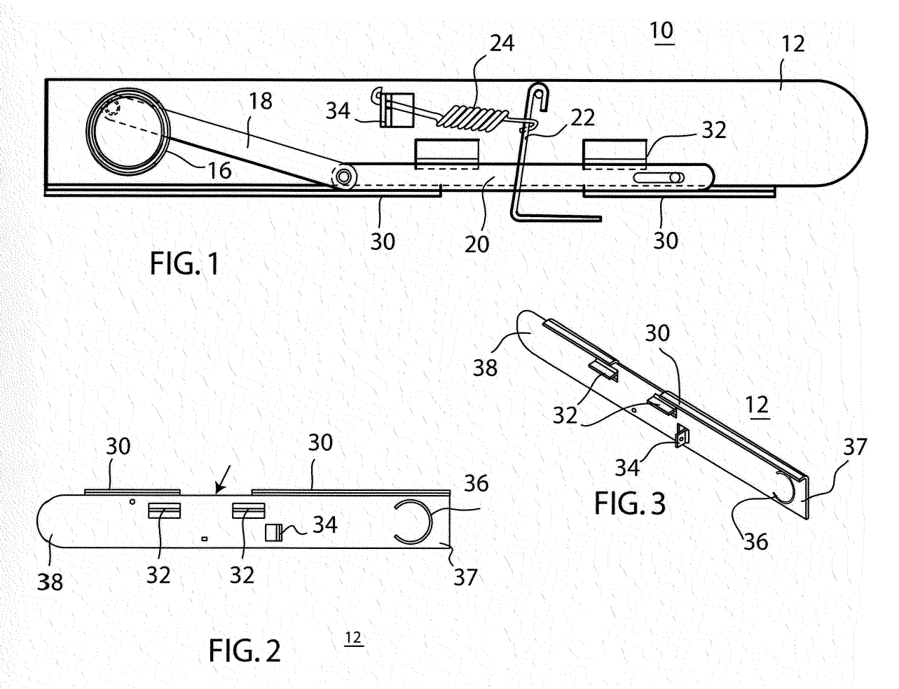

Referring to FIG. 1, an infinitely adjustable armrest 10, in accordance with the present invention, is illustrated. Armrest 10 includes a substrate 12, an outer tube 14, an inner tube 16, a slave link 18, a lock link 20, a lock mechanism 22, and an extension spring 24 (biasing member). It will be understood by those skilled in the art that armrest 10 will generally be associated with a seat such as those used in airplanes, busses, trucks, trains and other vehicles as desired, but that armrest 10 can be used with any seat or other device to which a movable armrest might be attached, including desk chairs and the like. It will also be understood that certain arm supporting structure and padding will generally be included in the armrest with the mechanism illustrated but this structure is not shown in this embodiment, since it is not a part of this invention and to better illustrate the operating mechanism of armrest 10.

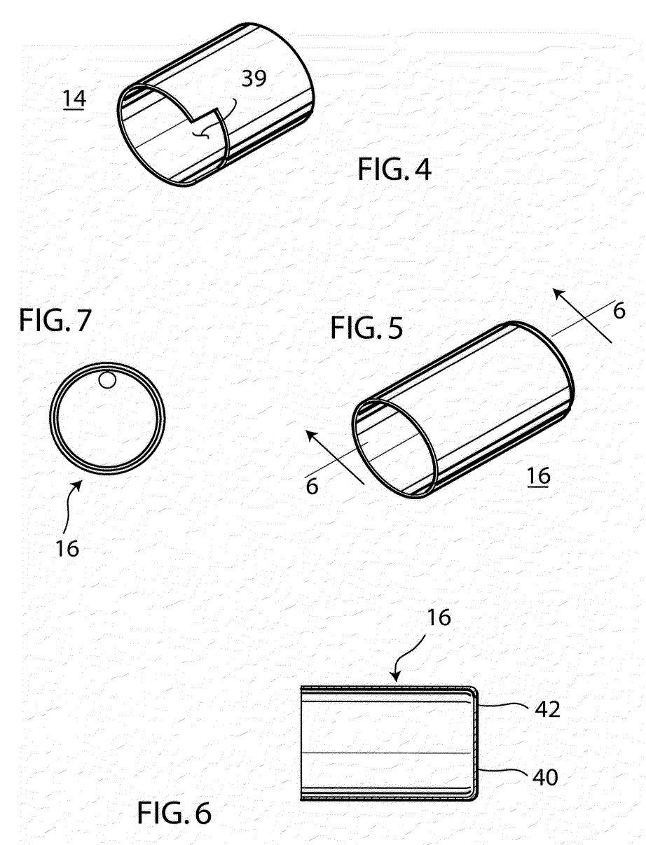

Referring additionally to FIGS. 2 and 3, substrate 12 is illustrated in more detail. Substrate 12 includes flanges 30 formed perpendicular to the main body of substrate 12 along a lower edge (upper edge in FIGS. 3 and 4) and breaks in the main body of substrate 12 formed into flanges 32 that are parallel with and spaced from flanges 30. Together, flanges 30 and 32 form a track (or guide) in which lock link 20 is positioned and movable in a reciprocating manner. Another break in the main body of substrate 12 forms a vertical flange 34 that is positioned to have one end of extension spring 24 attached thereto. An arcuate slot 36 is formed in the main body of substrate 12 adjacent one end 37. For purposes of this disclosure the one end 37 will be referred to as the rear end and the opposite end, designated 38, will be referred to as the front or forward end. Arcuate slot 36 is substantially circular and extends for approximately 270° and may extend a few degrees (e.g. up to 5°) more or less.

Referring additionally to FIG. 4, outer tube 14 is illustrated in more detail. Outer tube 14 is a generally hollow cylinder with a rectangular notch 39 cut out of the periphery at one end. Notch 39 extends approximately 90° and may extend a few degrees (e.g. up to 5°) more or less around the periphery. Further, tube 14 is designed and constructed to be fixedly engaged in slot 36 of substrate 12 so as to form an arcuate slot between substrate 12 and tube 14 and rotate with substrate 12 as armrest 10 is pivoted. In a preferred embodiment, substrate 12 and most of the other components can be formed of metal, such as sheet metal, sheet steel, or a sufficiently rigid and rugged plastic so that tube 14 could be fixed in place for example by welding or some compatible adhesive.

Referring additionally to FIGS. 5, 6, and 7, inner tube 16 is illustrated in more detail. Inner tube 16 is a generally hollow cylinder with one end 40 closed to form a generally circular cylindrical cup-shape. A mounting hole 42 is formed in end 40. Inner tube 16 is designed and formed to be fixedly attached to a seat back or the like and to be rotatably received within outer tube 14. Thus, as will be better understood from the following description, armrest 10 is substantially supported on a seat back or the like by outer tube 14 rotatably nested over inner tube 16. It will of course be understood that inner tube 16 could be a short section, as shown and be attached to, for example, a side of a seat back (not shown) or could extend through the seat back and out the other side to provide a mount for a second infinitely movable armrest 10, if desired.

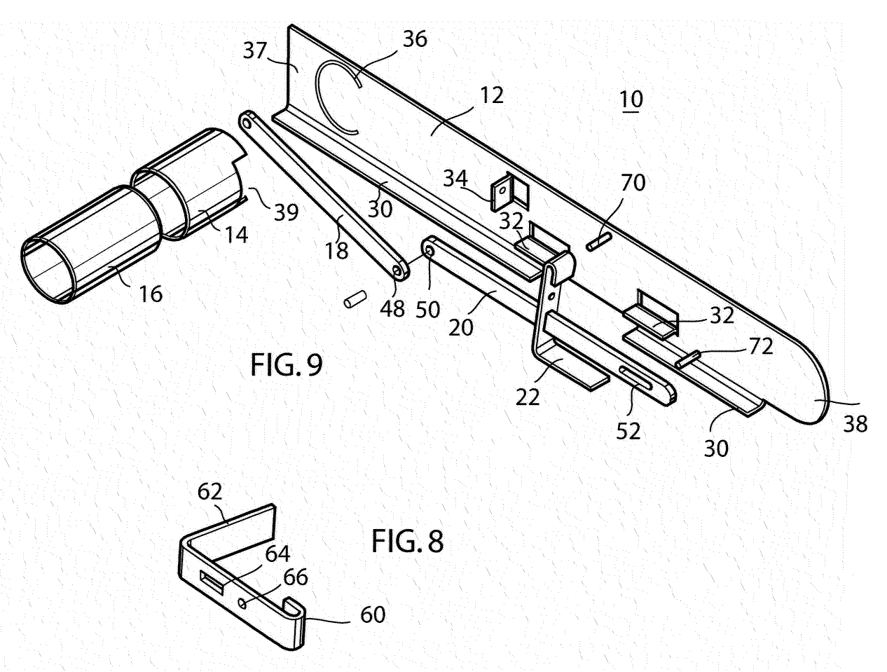

With momentary reference to FIG. 9, slave link 18 and lock link 20 are clearly illustrated. Slave link 18 is an elongated link or strip of rigid material formed with mounting holes 46 and 48 adjacent opposite ends. Lock link 20 is an elongated link or strip of rigid material formed with a mounting hole 50 and 48 adjacent one end and a longitudinally extending guide slot 52 extending from adjacent the opposite end toward the one end.

Referring additionally to FIG. 8, lock mechanism 22 is illustrated in more detail. Lock mechanism 22 includes multiple portions in a single element in this embodiment. As will be described in a subsequent embodiment, the various portions can be supplied separately. Lock mechanism 22 is formed from an elongated link or strip of rigid material bent approximately 360° at one end to form a hook 60. The strip of material is bent approximately 98° (generally L-shaped), give or take a few degrees, adjacent the opposite end to form an adjustment lever 62, as will be understood from the following description. A longitudinally extending locking slot 64 is formed through the main body (locking element) of lock mechanism 22. An opening 66 is formed in the main body of lock mechanism 22 and positioned to receive an opposite end of extension spring 24.

The relative positions of the various components described above are illustrated in FIG. 9. Referring to FIGS. 1 and 9, the assembly of the various components described above can be seen. A pivot pin is fixed concurrently through mounting hole 46 of slave link 18 and mounting hole 42 in inner tube 16 to pivotally attach slave link 18 to inner tube 16. Inner tube 16 is then nestingly or coaxially positioned in outer tube 14 with slave link 18 positioned in peripheral notch 39 and outer tube 14 is fixed in slot 36 of substrate 12. As described above, inner tube 16 is affixed to the back rest of a seat or the like on which armrest 10 is to be an armrest.

A mounting or pivot pin 70 is affixed to substrate 12 adjacent the upper edge so as to extend generally perpendicular to the surface parallel to and between flanges 32. Hook 60 of lock mechanism 22 is positioned over pivot pin 70 with lock mechanism 22 hanging downwardly from adjacent the upper edge. The length of the main body of lock mechanism 22 is such that adjustment lever 62 is positioned below the lower surface of substrate 12 (as illustrated in FIG. 1). Lock link 20 is inserted through slot 64 in lock mechanism 22 so as to be slideably engaged therein. A pivot pin is fixed concurrently through mounting hole 48 of slave link 18 and mounting hole 50 in lock link 20 to pivotally attach lock link 20 to slave link 18. In this fashion lock link 20 is slideably engaged in the track formed or defined by flanges 30 and 32.

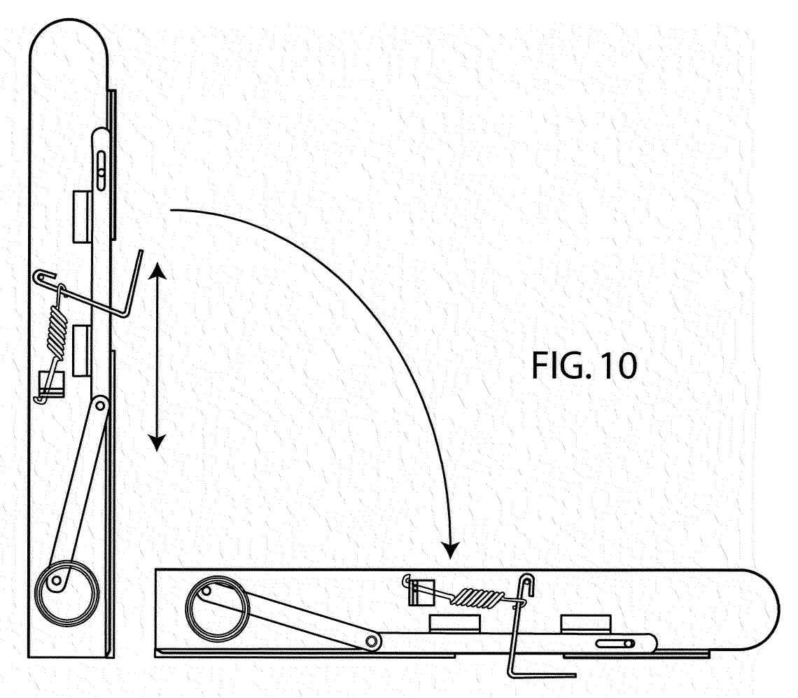

Also a stop pin 72 is affixed to substrate 12 and spaced above flange 30 so as to extend generally perpendicular to the surface parallel to and spaced above the flanges 30 adjacent forward end 38 of substrate 12. Stop pin 72 is positioned to extend through slot 52 in lock link 20. Extension spring 24, which is a tension spring, is connected between vertical flange 34 and opening 66 in lock mechanism 22. Spring 24 biases lock mechanism 22 rearwardly (toward rear end 37) which is the locked position of lock mechanism 22. In the locked position lock link 20 is frictionally engaged with the top and bottom edges of slot 64 in lock mechanism 22 and lock link 20 cannot move further toward rear end 37 of substrate 12. However, lock link 20 will move freely toward the front end 38 of substrate 12 and, thus, armrest 10 can be easily moved from any position, such as the horizontal position illustrated in FIG. 10 toward the vertical position. Once moved toward the vertical position, armrest 10 is prevented from moving back toward any lowered position. Further, armrest 10 can be positioned at any of an infinite number of positions between the upper and lower positions illustrated in FIG. 10 by simply raising adjustment lever 62 (i.e. rotating adjustment lever 62 counterclockwise in FIG. 10), moving armrest 10 to a desired position upwardly or downwardly, and releasing adjustment lever 62 to lock armrest 10 and prevent downward movement from the selected position.

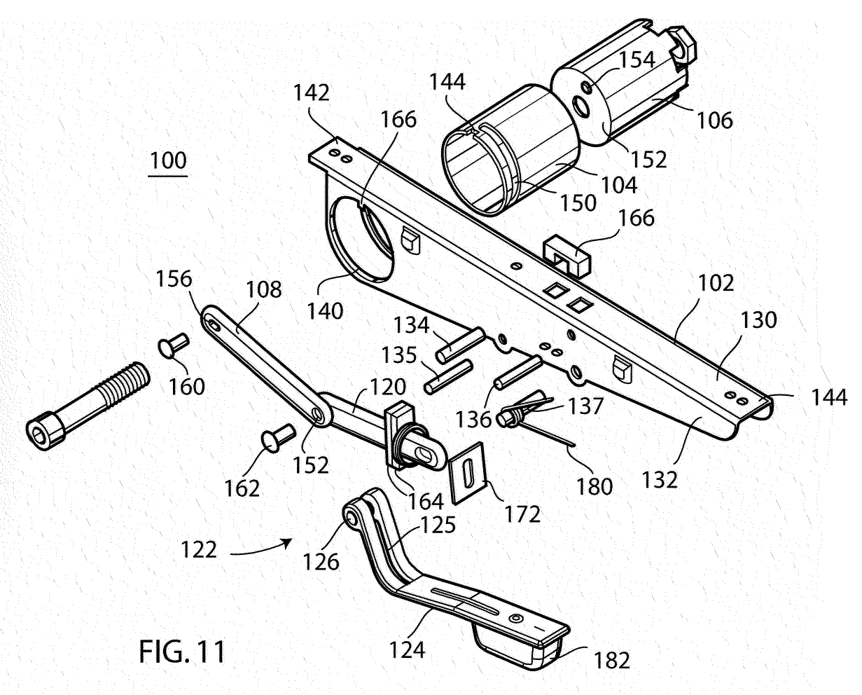

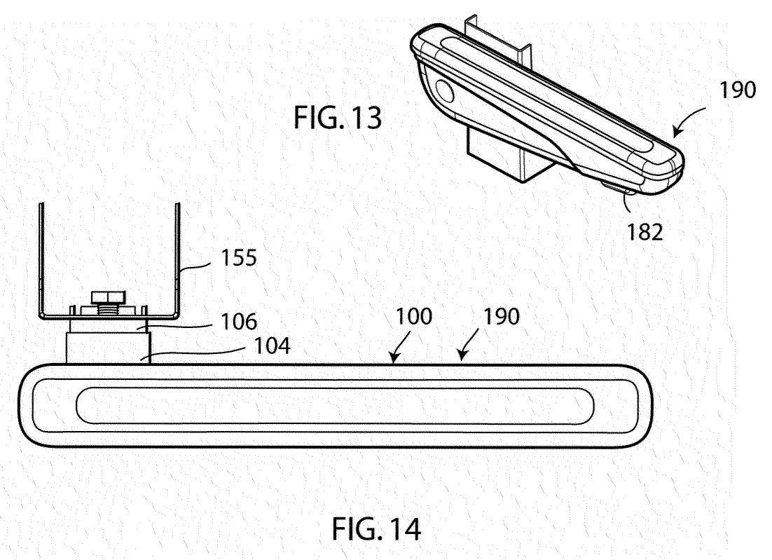

Turning now to FIG. 11, another embodiment of an infinitely adjustable armrest, designated 100 (seen in entirety in FIGS. 13 and 14) is illustrated. Armrest 100 includes a substrate 102, an outer tube 104, an inner tube 106, a slave link 108, a lock link 120, and a lock mechanism 122 including a manually operated adjustment lever 124.

In this embodiment substrate 102 is formed in the shape of an elongated channel with a generally U-shaped cross-section for additional strength. Substrate 102 has a channel bottom 130 with a first side 132 and an opposed side 134 generally parallel and spaced from each other. Four pins, 135, 136, 137, and 138, extended across the channel between sides 132 and 134 to form a guide or track in which lock link 120 is positioned and movable in a reciprocating manner. An opening 140 is formed so as to extend through each of the sides 132 and 134 of substrate 102 adjacent one end 142. For purposes of this disclosure the one end 142 will be referred to as the rear end and the opposite end, designated 144, will be referred to as the front or forward end.

Outer tube 104 is a generally hollow cylinder with a rectangular alignment notch 144 cut out of the periphery at one end. Further, tube 104 is designed and constructed to be fixedly engaged in opening 140 of substrate 102 by some convenient means, such as welding or the like. In the assembly process notch 144 is designed to mate with a small rectangular protrusion 146 to accurately align outer tube 104 within substrate 102. This alignment is described because outer tube 104 includes a circumferentially extending arcuate slot 150 through which slave link 108 extends, as will be described in more detail presently. In a preferred embodiment, substrate 102 and most of the other components can be formed of metal, such as sheet metal, sheet steel, or a sufficiently rigged and rugged plastic so that tube 104 could be fixed in place for example by frictional engagement, welding or some compatible adhesive.

Inner tube 106 is a generally hollow cylinder with one end 152 closed to form a generally circular cylindrical cup-shape. A mounting hole 154 is formed in end 152. Inner tube 106 is designed and formed to be fixedly attached to a seat back 155 or the like (see FIG. 14) and is received within outer tube 104 for relative rotation therewith. Thus, as will be better understood from the following description, armrest 100 is substantially supported on a seat back or the like by outer tube 104 rotatably nested over inner tube 106. It will of course be understood that inner tube 106 could be a short section, as shown and be attached to, for example, a side of a seat back 155 or could extend through the seat back and out the other side to provide a mount for a second infinitely movable armrest 100, if desired.

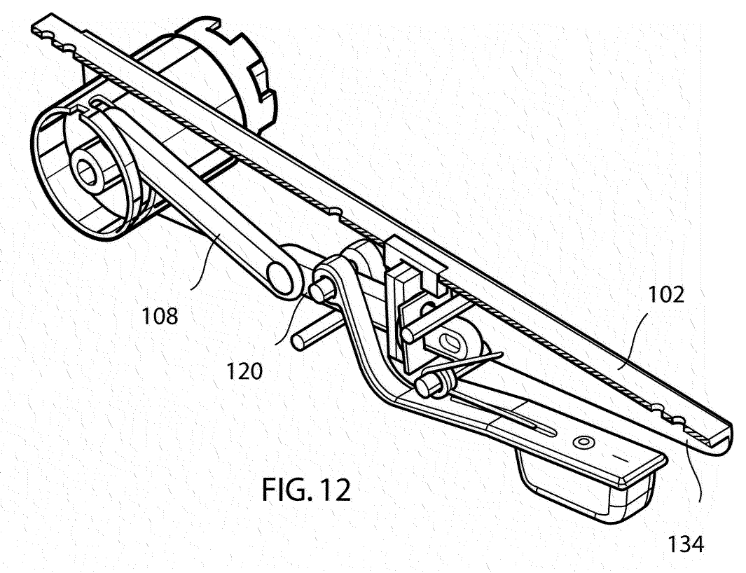

With additional reference to FIG. 12, slave link 108 and lock link 120 are clearly illustrated in the assembled position. Slave link 108 is an elongated link or strip of rigid material formed with mounting holes 156 and 158 adjacent opposite ends. Lock link 120 is an elongated link or strip of rigid material formed with a mounting hole adjacent the rear end. A pivot pin 160 extends through hole 156 in slave link 108 and into mounting hole 154 in the end of inner tube 106. A pivot pin 162 extends through hole 158 in slave link 108 and into the mounting hole adjacent the rear end of lock link 120 so that lock link 120 is pivotally attached to slave link 108 and moves with a reciprocal movement within the guide.

Circumferentially extending slot 150 has a length which limits upper and lower rotational movement of substrate 102 and therefore, armrest 100. As substrate 102 is rotated, outer tube 104 rotates relative inner tube 106 and slot 150 moves relative to slave link 108. Relative movement of slave link 108 within slot 150 is limited by contact of slave link 108 with the opposing ends of slot 150. In other words when slave link 108 contacts the upper end of slot 150, downward movement of substrate 102 is stopped, and when slave link 108 contacts the lower end of slot 150, upward movement of substrate 102 is stopped. Thus, the range of movement of armrest 100 can be modified by increasing or decreasing the length of slot 150.

In this embodiment lock mechanism 122 includes a pair of lock plates 164 each having a slot defined therethrough with dimensions slightly larger than the cross-sectional dimensions of lock link 120 and lock link 120 is positioned within the slots for lateral movements therein. Lock plates 164 are rotatably held within the channel of substrate 102 by means of a U-shaped lock pivot 166. Lock pivot 166 extends through openings in the channel bottom 130 and the upper ends of lock plates 164 are held therein by lock link 120 for limited pivotal movement. A compression spring 170 is positioned around lock link 120 abutting lock plates 164 on the forward side. A spring plate 172 having a slot therethrough is positioned around lock link 120 between compression spring 170 and pins 136, 137 through substrate 102. Thus, spring plate 172 holds compression spring 170 against lock plates 164 so that lock plates 164 are biased rearwardly or into a locked position. That is, lock link 120 is frictionally engaged by lock plates 164 which cause a “binding” that prevents forward movement of lock link 120 through lock plates 164. This binding results in substrate 102 (and armrest 100) being locked in the particular vertical orientation selected, i.e. substrate 102 and thus the armrest cannot move downwardly.

In this embodiment manually operated adjustment lever 124 of locking mechanism 122 is an elongated element bifurcated adjacent the rear end so as to form an elongated slot 125. Holes 126 adjacent the rear end are used to pivotally mount lever 124 on pin 134 within the channel of substrate 102 with lock link 120 extending through slot 125. An optional return spring 180 is held on pin 137 and biases lever 124 downwardly and helps eliminate unwanted movement. Thus, in the at-rest position illustrated in FIG. 12, locking mechanism 122 binds lock link 120 in whatever position it is in. By manually lifting lever 124 upwardly, generally by pressing upwardly on portion 182 which is externally accessible, lever 124 bears against the bottom of lock plates 164, pivoting lock plates 164 forwardly and thereby temporarily releasing lock link 120 for forward movement. It will be understood that lock mechanism 122 does not prevent upward movement of substrate 102 and the associated armrest. Thus, substrate 102 and the associated armrest can simply be moved upwardly to any desired position and locking mechanism 122 holds it in the desired position against downward movement. To adjust substrate 102 and the associated armrest downwardly, the operator simply presses upwardly on portion 182 and moves it to the desired position.

Referring additionally to FIGS. 13 and 14, a housing 190 is illustrated that surrounds and encloses substrate 102 and the associated mechanism to form infinitely adjustable armrest 100. As can be seen, portion 182 of manually operated adjustment lever 124 is externally accessible through housing 190 for convenient access and use.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. Apparatus mounting an armrest to a seatback with infinite adjustments, the apparatus comprising:
an inner tube affixed to the seatback and an outer tube affixed to the armrest and coaxially mounted over the inner tube so as to rotatably nest the outer tube over the inner tube;
a substrate affixed to the outer tube for rotational movement about the inner tube, and a guide formed on the substrate;
a slave link pivotally attached to the inner tube;
a lock link pivotally attached to the slave link and positioned in the guide for reciprocal movement relative to the substrate;
a lock mechanism mounted on the substrate, the lock link being slideably engaged with the lock mechanism for relative movement between the lock link and the lock mechanism, the lock mechanism being movable between a locked position in which the lock mechanism frictionally engages the lock link and an unlocked position in which the lock link is free to slide relative to the lock mechanism, and the lock mechanism further including a manually operated adjustment lever positioned to temporarily move the lock mechanism from the locked position into the unlocked position; and
a biasing spring coupled between the substrate and the lock mechanism for biasing the lock mechanism into the locked position to hold the lock link and the armrest in a selected position.

2. The apparatus of claim 1 wherein the lock link is slideably engaged through a slot in the lock mechanism and the lock mechanism frictionally engages the lock link to prevent downward rotation of the armrest in the locked position and allows upward rotation of the armrest in the locked position.

3. The apparatus of claim 1 wherein one end of the slave link is pivotally attached to one end of the inner tube, the outer tube has a circumferentially extending slot therethrough with the slave link extending through the slot and an opposite end of the slave link being pivotally attached to one end of the lock link.

4. The apparatus of claim 1 wherein the lock mechanism includes an L-shaped element with a generally vertical arm and a generally horizontal arm, the vertical arm is pivotally mounted on the substrate adjacent an upper end and has a vertically extending slot therethrough positioned to receive the lock link therethrough, the horizontal arm forms the adjustment lever arm.

5. The apparatus of claim 4 wherein the biasing spring is connected to the vertical arm of the lock mechanism and biases the lock mechanism toward the slave link.

6. The apparatus of claim 1 wherein the lock mechanism includes a lock plate coupled to the substrate, the lock plate defines a vertically extending slot receiving the lock link therethrough for relative reciprocal movement, the lock plate being movable between a locked position in which the lock plate frictionally engages the lock link and an unlocked position in which the lock link is free to slide relative to the lock plate.

7. The apparatus of claim 6 wherein the lock mechanism further includes a spring plate mounted relative to the substrate and the biasing spring includes a compression spring positioned between the lock plate and the spring plate to bias the lock plate into the locked position.

8. The apparatus of claim 1 wherein the substrate is a generally flat piece of material with a flat surface and the guide formed on the substrate includes flanges formed in the substrate and extending outwardly from the flat surface to define a track therebetween.

9. The apparatus of claim 1 wherein the substrate is a channel piece with a generally U-shaped cross-section with the slave link, the lock link, and the lock mechanism positioned in the channel piece.

10. The apparatus of claim 1 further including a stop pin fixed to the substrate and positioned to extend through a longitudinally extending slot in the lock link, the stop pin is further positioned to limit movement of the lock link and the associated armrest.

11. The apparatus of claim 1 further including a stop mechanism wherein the outer tube has a circumferentially extending slot therethrough with the slave link extending through the slot, the slot having a length which limits upper and lower movement of the armrest through contact with the slave link.

12. Apparatus mounting an armrest to a seatback with infinite adjustments, the apparatus comprising:
an inner tube affixed to the seatback and an outer tube affixed to the armrest and coaxially mounted over the inner tube so as to rotatably nest the outer tube over the inner tube;
a substrate affixed to the outer tube, the substrate being a piece of material with a flat surface and including elements extending outwardly from the flat surface to define a track therebetween;
a slave link pivotally attached to the inner tube;
a lock link positioned in the track and reciprocally movable relative to the substrate, the lock link being pivotally attached to the slave link;
a lock mechanism including a locking element pivotally mounted adjacent an upper end on the substrate and defining a vertically extending slot positioned to receive the lock link therethrough and an adjustment lever arm;
the lock link slideably received through the vertically extending slot of the lock mechanism for relative movement between the lock link and the lock mechanism, the lock mechanism being movable between a locked position in which the locking element is frictionally engaged with the lock link and an unlocked position in which the lock link is free to slide relative to the locking element, and the adjustment lever arm temporarily moving the locking element from the locked position into the unlocked position; and
a spring connected between the substrate and the locking element for biasing the lock mechanism into the locking position to hold the lock link and the armrest in a selected position.

13. The apparatus of claim 12 wherein the lock mechanism further includes an L-shaped element with a generally vertical arm and a generally horizontal arm, the vertical arm being pivotally mounted adjacent an upper end on the substrate and defining the locking element, the horizontal arm forming the adjustment lever arm.

14. Apparatus mounting an armrest to a seatback with infinite adjustments, the apparatus comprising:
an inner tube affixed to the seatback and an outer tube coaxially mounted over the inner tube so as to rotatably nest the outer tube over the inner tube;
an elongated channel shaped substrate with a generally U-shaped cross-section and a lateral opening extending through opposed sides of the substrate, the outer tube being affixed in the lateral opening so as to extend laterally outwardly therefrom, and a guide formed between the opposed sides of the substrate;
a slave link having proximal and distal ends and pivotally attached to the inner tube, the proximal end of the slave link being pivotally attached to one end of the inner tube, the outer tube having a circumferentially extending slot therethrough with the slave link extending through the circumferentially extending slot;
a lock link positioned in the guide and movable generally longitudinally relative to the substrate, one end of the lock link being pivotally attached to the distal end of the slave link for reciprocal movement generally along the elongated channel shaped substrate in response to rotary movement of the outer tube and the attached substrate;
a lock mechanism including a lock plate coupled to the substrate, the lock plate defining a vertically extending slot positioned to receive the lock link therethrough for relative reciprocal movement, the lock plate being movable between a locked position in which the lock plate is frictionally engaged with the lock link and an unlocked position in which the lock link is free to slide relative to the lock plate;
a biasing spring coupled between the substrate and the lock plate for biasing the lock plate into the locked position to hold the lock link and the armrest in a selected position; and
an adjustment lever positioned to move the lock plate from the locked position into the unlocked position.

15. The apparatus of claim 14 wherein the lock mechanism further includes a spring plate fixedly mounted relative to the substrate and the biasing spring is a compression spring mounted between the lock plate and the spring plate to bias the lock plate into the locked position.

16. The apparatus of claim 14 further including a housing surrounding and enclosing the elongated channel shaped substrate.

17. The apparatus of claim 16 wherein the adjustment lever is positioned within the housing and includes an externally accessible actuating portion.
